(19) United States
(12) Patent Application Publication
(10) Pub. No.: US 2007/0034685 A1
(43) Pub. Date: Feb. 15, 2007

(54) Real-time verification of a transaction by its initiator

(75) Inventor: Douglas N. Botham, Erie, CO (US)

Correspondence Address: AVAYA INC., 307 MIDDLETOWN-LINCROFT ROAD, ROOM 1N-391, LINCROFT, NJ, 07738, US

(73) Assignee: Avaya Technology Corp.

(21) Appl. No.: 11/202,296

(22) Filed: Aug. 12, 2005

(51) Int. Cl. G06K 5/00; G06Q 40/00

(52) U.S. Cl. 235/380; 235/382; 705/44

(57) ABSTRACT

A transaction-enabling instrument, such as a credit card, a debit card, or a check, has encoded thereon in machine-readable form a telephone number of a portable wireless communications device, such as a cell phone or a PDA, of the instrument's owner, who is typically the holder of the instrument, and a transaction-authentication code. When the holder presents the instrument to enable a transaction, a reader reads the phone number and code, and an authentication server causes the phone number to be dialed and the owner to be prompted for the authentication code. If the owner provides the code, the server allows the transaction to proceed. If the owner cannot be reached or does not provide the code, the server denies the transaction.

### TECHNICAL FIELD

This invention relates to the field of transaction verification.

### BACKGROUND OF THE INVENTION

In today's “cashless economy” where instruments such as credit cards, debit cards, and checks have supplanted cash as a normal method of payment, unauthorized use of such instruments is a serious problem. For example, these instruments may be stolen and used by someone pretending to be their rightful owner. Various techniques are known for combating this problem. For example, a picture of the owner of a credit card may be printed on the card to allow a merchant to compare the identity of the presenter of the card with the identity of the card's owner. Or, a security code may be programmed into a valid card. Some credit cards have limits on the amount of transactions for which they can be used, or an ability for the user to turn the card on or off. Other credit cards allow the owner to specify circumstances, such as a transaction-amount threshold or a number of transactions, after which the owner must be contacted to approve a pending transaction.

Unfortunately, while helpful, none of these approaches fully solve the problem. For example, a merchant may not check the information on the card carefully enough to ensure that the card holder matches the card owner. The security code is not helpful if the thief has actually stolen the real card. Moreover, an identity thief can reproduce a credit card with a name and a picture corresponding to the thief. Transaction limits still allow the thief to misuse the instrument for as long as the thief stays below the limit. And turning on and off the instrument is a significant bother for the instrument holder.

### SUMMARY OF THE INVENTION

This invention addresses the problems of the prior art.

According to one aspect of the invention, a method of verifying a transaction comprises the following steps: a presenter of an instrument for effecting a transaction presents the instrument to a machine. The instrument has encoded thereon a machine-readable identifier of an owner of the instrument. In response to the presenting, the machine reads the identifier from the instrument. In response to the reading of the identifier, the machine contacts a portable communications device associated with the owner. In response to the contacting reaching the presenter through the device, the machine enables the transaction. And, in response to a failure of the contacting to reach the presenter through the device, the machine denies the transaction.

According to another aspect of the invention, a transaction-verification apparatus comprises a reader that responds to an identifier of an owner of an instrument for effecting transactions that has the identifier encoded thereon in machine-readable form, by reading the identification from the instrument upon being presented with the instrument by a presenter, and an authentication server, cooperative with the reader and responsive to the reading of the identifier, that contacts a portable communications device associated with the owner, responds to the contacting reaching the presenter through the device by enabling the transaction, and responds to a failure of the contacting to reach the presenter through the device by denying the transaction.

By involving the presenter of the instrument in the transaction-verification process by a mechanism that is normally not at the disposal of anyone but the instrument owner, the invention substantially ensures that the transaction is not performed by an unauthorized user of the instrument.

### BRIEF DESCRIPTION OF THE DRAWING

These and other features and advantages of the invention will become more apparent from a description of an illustrative embodiment of the invention considered with the drawing, in which:

FIG. 1 is a block diagram of an illustrative transaction system that implements an illustrative embodiment of the invention;

FIG. 2 is a block diagram of a transaction instrument of the system of FIG. 1; and

FIG. 3 is a flow diagram of operation of the system of FIG. 1.

### DETAILED DESCRIPTION

The invention takes advantage of the proliferation of wireless communication devices, such as cellular phones and personal digital assistants (PDAs), and the fact that most users carry their devices with them substantially at all times.

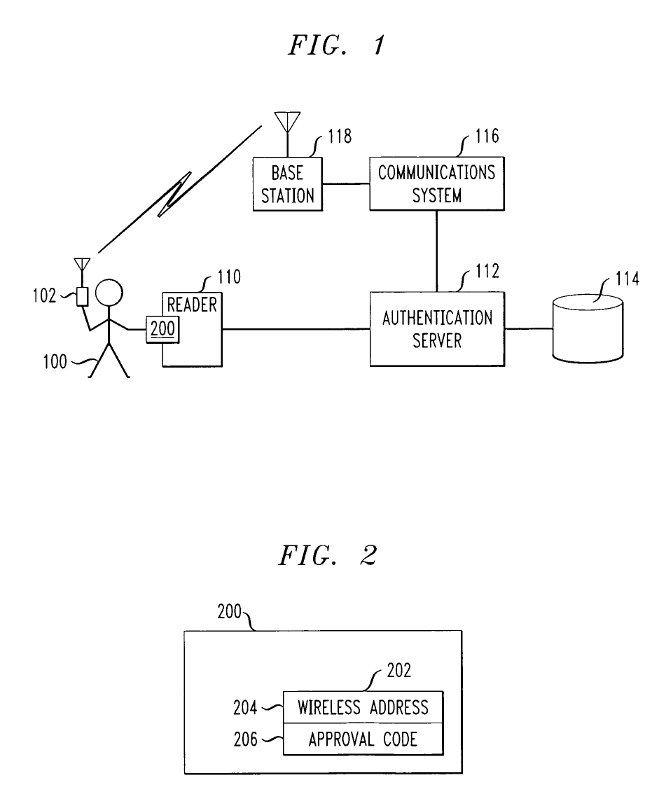

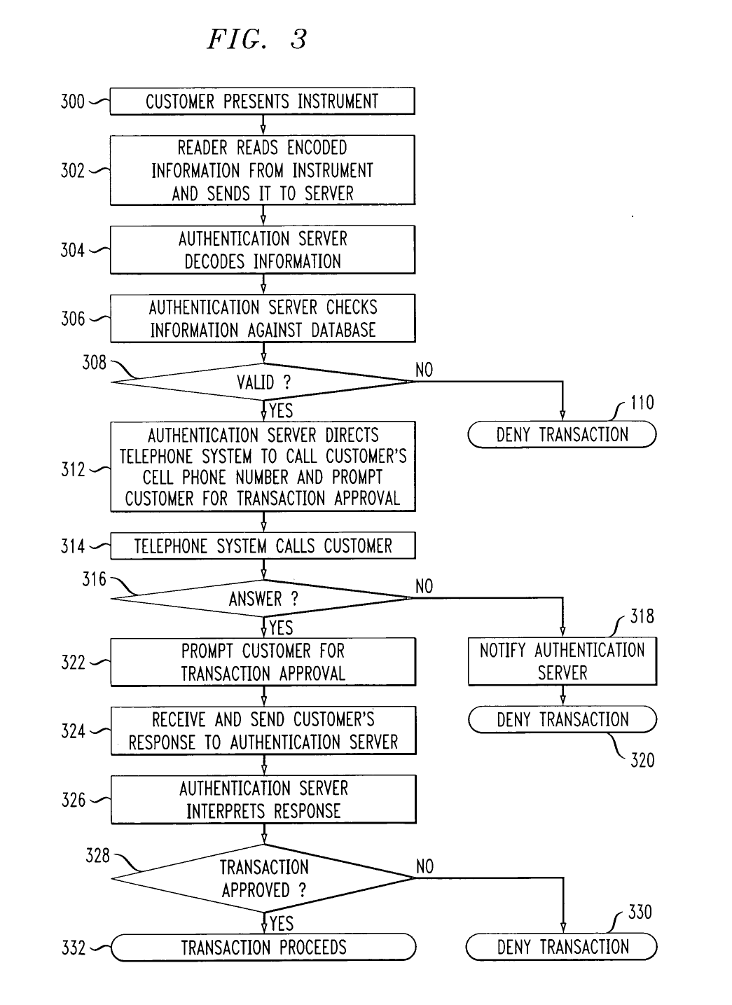

When initiating a transaction, such as a purchase, a user 100 who is carrying a wireless communication device 102 in FIG. 1 presents a transaction-enabling instrument 200, such as a credit card, a debit card, or a check, to the other party to the transaction, such as a merchant, at step 300 of FIG. 3. Instrument 200 of FIG. 2 has a machine-readable encoding 202 thereon—such as a magnetic strip or an RFID, for example—that contains a wireless address (e.g., a phone number) 204 of device 102 of the owner of instrument 200 and optionally a code 206 that is used to approve transactions made with instrument 200. Preferably, the information in encoding 202 is encrypted for greater security. This is in addition to information that instrument 202 usually carries, such as an account number. Encoding 202 on instrument 200 is read by an automatic reading device (reader) 110 in FIG. 1, such as a credit card reading terminal or an RFID reader, and reader 110 sends the read information to an authentication server 112 in FIG. 1, at step 302 of FIG. 3. Illustratively, server 112 is under the control of the issuer of instrument 200, such as a bank. Server 112 decodes (e.g., decrypts) the information received from reader 110, at step 304, and compares it against contents of a secure database 114 in FIG. 1 that stores identities—such as a name and an account number, for example—and related information—such as wireless address 204 and approval code 206, for example—of valid users of instruments such as instrument 200, in order to validate instrument 200, at step 306 of FIG. 3. If the received information does not match any entries of database 114, as determined at step 308, instrument 200 is deemed to be invalid and server 112 denies the transaction, at step 110.

If instrument 200 is validated at step 308, server 112 directs a wireless communications system 116 in FIG. 1—for example, telephone system private-branch exchange equipped with an auto-dialer and a voice-announcement circuit—to establish a communications connection with the received wireless address 204 and to prompt whoever answers the communication for approval of the transaction, at step 312 of FIG. 3. Communications system 116 communicates with an endpoint device that is assigned address 204—for example, telephone system 116 calls phone number 204 via a wireless base station 118 in FIG. 1 that is located in the vicinity of reader 110—at step 314 of FIG. 3, and awaits an answer. If instrument 200 or its account number was stolen, it is not likely that the thief will also have the instrument owner's device 102, and hence the thief will not be able to answer the communication. If the communication is not answered within a predetermined period of time, as determined at step 316 of FIG. 3, system 116 informs server 112, at step 318, and server 112 denies the transaction, at step 320.

If user 100 is the owner (or a proxy of the owner, subsumed herein under the term “owner”) of instrument 200, user 100 receives the wireless communication on device 102 and answers it, as determined at step 316, and system 116 or server 112 prompts user 100 to approve the transaction, at step 322. Approval may constitute speaking “yes” into device 102 or activating a particular activator (e.g., a button) on device 102. But to verify for greater security that the person answering the communication is the owner of instrument 200 and to handle the case where both instrument 200 and device 102 were stolen by the same person, approval preferably constitutes user 100 speaking approval code 206 into device 102 or keying in approval code 206 on the keypad of device 102.

System 116 receives the user's response and transports it to server 112, at step 324. Server 112 interprets the response (for example, by means of a voice-recognition mechanism if it is a voice response, and further by comparing it against approval code 206), at step 326. If it determines, at step 328, that the user's response is not a proper approval, server 112 denies the transaction, at step 330. If the user's response is a proper approval, server 112 enables the transaction to proceed in a conventional manner, at step 332.

Of course, various changes and modifications to the illustrative embodiment described above will be apparent to those skilled in the art. For example, the invention may be used to verify any desired transactions, not just purchases. Or device 102 may be any desired device, including a telephone, a PDA, a laptop computer, etc. The communication therewith can be effected via any desirable protocol, including text messaging, instant messaging, voice call, DTMF detection, etc. These changes and modifications can be made without departing from the spirit and the scope of the invention and without diminishing its attendant advantages. It is therefore intended that such changes and modifications be covered by the following claims except insofar as limited by the prior art.

What is claimed is:

1. A method of verifying a transaction, comprising:
a presenter of an instrument for effecting a transaction presenting the instrument to a machine, the instrument having encoded thereon a machine-readable identifier of an owner of the instrument;
in response to the presenting, the machine reading the identifier from the instrument;
in response to the reading of the identifier, the machine contacting a portable communications device associated with the owner;
in response to the contacting reaching the presenter through the device, the machine enabling the transaction; and
in response to a failure of the contacting to reach the presenter through the device, the machine denying the transaction.

2. The method of claim 1 wherein:
the reached presenter is the owner.

3. The method of claim 2 wherein:
enabling the transaction comprises
communicating with the owner through the device, which accompanies the owner,
in response to the communicating, the owner approving the transaction to the machine via the communicating through the device, and
in response to the approving, the machine enabling the transaction; and
denying the transaction comprises
in response to a failure to communicate with the owner or a failure of the owner to approve the transaction, the machine denying the transaction.

4. The method of claim 1 wherein:
the instrument further has encoded thereon a transaction-approving code;
reading the identifier comprises
the machine reading the code from the instrument;
enabling the transaction comprises
in response to the contacting reaching the presenter through the device, eliciting the code from the presenter via the device, and
in response to the eliciting, the machine enabling the transaction; and
denying the transaction comprises
in response to a failure to reach the presenter or to elicit the code from the presenter, denying the transaction.

5. The method of claim 1 wherein:
the identifier comprises an electronic communications address of the owner.

6. The method of claim 1 wherein:
the identifier comprises an electronic address of the portable communications device.

7. The method of claim 1 wherein:
the identifier comprises a telephone number of a wireless phone or a personal digital assistant of the owner.

8. The method of claim 3 wherein:
the instrument further has encoded thereon a transaction approving code:
reading the identifier comprises
the machine reading the code from the instrument;
approving comprises
the owner providing the code to the machine via the communications device, and
the machine comparing the read code with the provided code.

9. A method of verifying a transaction, comprising:
an owner of an instrument for effecting a transaction presenting the instrument to a machine, the instrument having encoded thereon a machine-readable identifier of the owner;
in response to the presenting, the machine reading the identifier from the instrument and using it to communicate with the owner through a portable communications device accompanying the owner;
in response to the communicating, the owner approving the transaction to the machine via the communicating through the mobile communications device;
in response to the approving, the machine enabling the transaction; and
in response to a failure to communicate with the owner or a failure of the owner to approve the transaction, the machine denying the transaction.

10. The method of claim 8 wherein:
the identifier comprises an electronic communications address of the owner.

11. The method of claim 8 wherein:
the identifier comprises an electronic address of the portable communications device.

12. The method of claim 8 wherein:
the identifier comprises a telephone number of a wireless phone or a personal digital assistant of the owner.

13. The method of claim 8 wherein:
the instrument further has encoded thereon a transaction-approving code;
reading the identifier comprises
the machine reading the code from the instrument; and
approving comprises
the owner providing the code to the machine via the communications device, and
the machine comparing the read code with the provided code.

14. A transaction-verification apparatus comprising:
an instrument reader, responsive to an identifier of an owner of an instrument for effecting transactions that has the identifier encoded thereon in machine-readable form, for reading the identification from the instrument upon being presented with the instrument by a presenter; and
an authentication server, cooperative with the reader and responsive to the reading of the identifier by contacting a portable communications device associated with the owner, responsive to the contacting reaching the presenter through the device, by enabling the transaction, and responsive to a failure of the contacting to reach the presenter through the device, by denying the transaction.

15. The apparatus of claim 14 wherein:
the presenter is the owner.

16. The apparatus of claim 15 wherein:
the authentication server effects communicating with the owner through the device, which accompanies the owner, responds to the owner approving the transaction via the communicating, by enabling the transaction, and responds to a failure to communicate with the owner or a failure of the owner to approve the transaction, by denying the transaction.

17. The apparatus of claim 14 wherein:
the instrument further has encoded thereon a transaction-approving code;
the instrument reader is further for reading the code from the instrument; and
the authentication server responds to the read code by causing the code to be elicited from the presenter via the contacting through the device, responds to the elicitation by enabling the transaction, and responds to a failure to reach the presenter or a failure to elicit the code from the presenter by denying the transaction.

18. The apparatus of claim 14 wherein:
the identifier comprises an electronic communications address of the owner.

19. The apparatus of claim 14 wherein:
the identifier comprises an electronic address of the portable communications device.

20. The apparatus of claim 14 wherein:
the identifier comprises a telephone number of a wireless phone or a personal digital assistant of the owner.

21. The apparatus of claim 16 wherein:
the instrument further has encoded thereon a transaction-approving code;
the instrument reader is further for reading the code from the instrument; and
the authentication server responds to the owner providing the code via the communications device to approve the transaction, by comparing the read code with the provided code.

22. A transaction-verification apparatus comprising:
an instrument reader responsive to an identifier of an owner of an instrument for effecting transactions that has the identifier encoded thereon in machine-readable form, for reading the identifier from the instrument upon being presented with the instrument by the owner; and
an authentication server cooperative with the reader, for effecting a communication with the identified owner through a portable communication device accompanying the owner, responsive to the owner approving the transaction via the communication through the device by enabling the transaction, and responsive to a failure to communicate with the owner or a failure of the owner to approve the transaction by denying the transaction.

23. The apparatus of claim 22 wherein:
the identifier comprises an electronic communications address of the owner.

24. The apparatus of claim 22 wherein:
the identifier comprises an electronic address of the portable communications device.

25. The apparatus of claim 22 wherein:
the identifier comprises a telephone number of a wireless phone or a personal digital assistant of the owner.

26. The apparatus of claim 22 wherein:
the instrument further has encoded thereon a transaction-approving code;
the instrument reader is further for reading the code from the instrument; and
the authentication server responds to the owner providing the code via the communications device to approve the transaction, by comparing the read code with the provided code.
